(19) United States
(12) Patent Application Publication
(10) Pub. No.: US 2007/0187853 A1
(43) Pub. Date: Aug. 16, 2007

(54) Preparation stage for trace collection system

(75) Inventors: Gil Perlberg, Zichron Yaakov (IL); Robert Landon Roach, Ramat Hasharon (IL)

Correspondence Address: TRACEGUARD TECHNOLOGIES INC., 6 Ravintzki St., P.O. Box 4708, Petach Tikva, 49277, IL

(73) Assignee: TRACEGUARD TECHNOLOGIES, INC.

(21) Appl. No.: 11/354,997

(22) Filed: Feb. 16, 2006

(51) Int. Cl. A61J 3/07; B29C 39/10

(52) U.S. Cl. 264/4

(57) ABSTRACT

Trace collection system including a conveyer appended to the entrance of the device, protected by a hood, and/or enclosed in a tunnel. The conveyor can perform preliminary checks on the inspected items, and gather information such as weight, dimension, and temperature, that can serve as parameters to a subsequent trace collection process.

### FIELD AND BACKGROUND OF THE INVENTION

The present invention relates to trace collection systems and, more particularly, to a preparation stage for enhancing the performance of a trace collection system.

Basic principles and details relating to trace collection system components needed for properly understanding the present invention are provided herein. Complete theoretical descriptions, details, explanations, examples, and applications of these and related subjects and phenomena are readily available in standard references in the fields of physics, electronics, and materials science

The term “trace” as used herein refers to any minute amount of material in solid, liquid or gas form, such as but not limited to, particles and vapor.

Existing trace collection systems (all existing methods are manual or small and local) are widely used for screening carry-on inspected items and personal belongings. Trace collection systems may collect the particles using a particle trace collection chamber or other means as known in the art. The particles are forwarded to a trace detection system that analyzes trace particles by various means as is known in the art.

The results of the particle trace collection process and of the particles detection process may typically be displayed at a monitoring station for a human operator to observe. Human operators may clear an inspected item and allow it to pass if no suspicious indicators are revealed. If suspicious indicators are revealed, the inspected item may be required to undergo additional levels of inspection, e.g., a physical search and further trace collection.

A trace collection system may include a conveyor. There are many conveyors used for moving inspected items known in the art. Trays for containing and/or protecting inspected items being passed to and from the trace collection system are often provided at the inspection station. For example, passengers passing through an airport security checkpoint will often place keys, coins and other metal objects in trays that are transported through the inspection region.

Passengers may also place luggage, cell phones, PDA's and other portable electronic devices in trays, enabling a more thorough inspection of the inspected items. Furthermore, passengers may be required to place coats, shoes, belts or other inspected items of clothing in trays for passing those inspected items through inspection region.

Typically, a stack of trays is provided at the entrance to the inspection station. Passengers place their inspected items in a tray and set the tray on a conveyor, which moves the tray and the inspected items in and out of the trace collection system. The trays may accumulate at the exit region until an operator carries them back to the entry point of the inspection station or they may be transported by an automated tray circulation system

A number of methods are available for bringing articles to a machine. However there is no prior art pertaining to tray and/or conveyor enhancing the performance of a trace collection system by implementing additional operations on the inspected item.

U.S. Pat. No. 6,082,522, issued to Ludger Polling, titled “Tilting-conveying element for a sorter-conveyer”, discloses a tilting-conveying element for a sorter-conveyer for sorting parcels, particularly luggage pieces, comprising an essentially planar carrying base, which can be tilted from its essentially horizontal normal position around a tilting shaft running essentially in its longitudinal direction to an at least slanted delivery position, and on each of whose longitudinal edges, running essentially in its longitudinal direction, a side wall is arranged, which forms a lateral limit stop in the normal position of the carrying base, at least one side wall being movably mounted relative to the carrying base on the tilting-conveying element such that it can be moved from its limit-stop position to a second position, in which it no longer protrudes over the upper side of the carrying base, so as to form a limit stop.

U.S. Pat. No. 3,587,829, issued to Robert p. Sorensen, titled “conveyor with interchangeable receivers”, discloses conveyor with interchangeable receivers.

U.S. Pat. No. 3,880,298, issued to James D. Habegger, titled “Sorting conveyor control system”, discloses an endless loop sorting conveyor includes a plurality of article-carrying trays which receive randomly fed articles from one or more induction stations and selectively discharge the articles onto a plurality of discharge chutes adjacent the conveyor such that articles on trays identified by destination codes for the articles thereon will be sorted by discharging the articles onto correspondingly identified discharge chutes.

U.S. Pat. No. 6,580,778, issued to Claus Meder, tilted “inspection device”, discloses an inspection device for inspecting objects, particularly for explosives. The invention makes provision, particularly where space for the inspection system is tight, to use at least the available area as a scanning area, around which is arranged at least one movable radiation source at which is aimed a detector arrangement that can be moved mechanically independently of the radiation source. In this context, the radiation source and the detector arrangement can be moved parallel to and simultaneously with one another by mechanical or electrical coupled actuators. The synchronous movement is controlled and monitored with the aid of a computer.

U.S. Pat. No. 6,321,904, issued to Charles Mitchell, titled “conveyor belt with locking member for holder elements”, discloses a conveyor apparatus for transporting inspected items via an endless conveyor belt having at least one locking member. At least one interchangeable holder element is adapted to releasably interlock with the locking member provided on the conveyor belt, with the locking member exerting a downward force on the holder element when tension is applied to the belt in use. As a result, the holder element is preloaded against the outer surface of the belt. The preload is at least partially decreased when traveling in an accurate path about the end pulleys of the conveyor system. Accordingly, the holder elements may easily be removed and replaced without adjusting the tension of the conveyor belt.

US patent application number 20050006209, issued to Brian Lynge Sorensen, titled “Tote for conveyor”, discloses a tote for a conveyor system having an upper part defining an upper, article-supporting surface being of concave cross-section, and a lower part defining a lower, substantially plane bearing surface that extends an area substantially equal to the article-supporting surface. The upper part and the lower part being non-opaque i.e. transparent to x-rays, wherein the lower part is injection molded from a plastics material, the plastics material being preferably wear resistant. The preferred shape and type of the tote is one wherein the upper part and the lower part together form a substantially closed, hollow body. A damping means may be included in the hollow structure, i.e. in a cavity between the upper part and the lower part of the tote. This will silence the conveyor system when operated. The damping means may be made of foam rubber, preferably in a fire-retardant form.

However, the just described methods, devices, and systems are notably limited because there is no description of using the tray and/or the conveyor for enhancing and/or improving trace extraction and collection and/or reducing the cost of a trace collection system.

To date, the inventor is unaware of prior art teaching the use of conveyors which brings articles to a trace collection system, but only conveyors that are used by machines such as x-ray machine.

Moreover, the inventor is unaware of prior art teaching of a tray and/or a conveyor for enhancing and/or improving and/or reducing the cost of a trace collection system.

There is thus a need for, and it would be highly useful, to have a tray for enhancing the performance of a trace collection system.

It is also desirable to have a conveyer for enhancing the performance of a trace collection system.

### SUMMARY OF THE INVENTION

Thus, according to the present invention, there is provided a trace collection system including: (a) at least one preparation stage for at least one inspected item, whereby the inspected item is enclosed in a tunnel, and (b) a particle collection system, whereby the particle collection system collects a portion of the released particles and the portion of the released particles is analyzed for traces of at least one predefined chemical.

According to further features in preferred embodiments of the present invention, the system further including at least one encapsulating device having volume determined according to the inspected item.

According to still further features in the described preferred embodiments, the system further including a particle release mechanism applied on the inspected item.

According to still further features in the described preferred embodiments, the preparation stage is a conveyor.

According to still further features in the described preferred embodiments, the conveyor further includes at least one liquid detection sensor.

According to still further features in the described preferred embodiments, the conveyor further includes at least one sound measurement sensor.

According to still further features in the described preferred embodiments, the conveyor further includes at least one vibrating mechanism.

According to still further features in the described preferred embodiments, the conveyor further includes at least one dimension measurement sensor.

According to still further features in the described preferred embodiments, the conveyor further includes at least one weight measurement sensor.

According to still further features in the described preferred embodiments, the conveyor further includes at least one heating device.

According to still further features in the described preferred embodiments, the conveyor further includes at least one temperature measurement sensor.

According to another aspect of the present invention, there is provided a method for forming a chamber around at least one inspected item, applying at least one particle release measure on the inspected item, and collecting released particles, including the step of preparing the inspected item before the inspected item is encapsulated.

According to further features in the described preferred embodiments, the method further includes the step of detecting the presence of a possible spillage.

According to still further features in the described preferred embodiments, the preparing further includes the step of vibrating the inspected item.

According to still further features in the described preferred embodiments, the preparing further includes the step of measuring the dimensions of the inspected item, whereby the measurements serve as parameters in an optimization of the particle collection process.

According to still further features in the described preferred embodiments, the preparing further includes the step of measuring the weight of the inspected item, whereby the weight measurements serve as parameters in an optimization of the particle collection process.

According to still further features in the described preferred embodiments, the preparing further includes the step of measuring the weight and dimensions of the inspected item, whereby the weight and dimensions measurements are used to compute a gross density of the inspected item.

According to still further features in the described preferred embodiments, the preparing further includes the step of heating the inspected item.

The present invention successfully enhances the performance of a trace collection system. The method of the present invention is readily implemented using standard materials and hardware. Implementation of the method and device of the present invention involves performing or completing selected tasks or steps manually, semi-automatically, fully automatically, and/or a combination thereof. Moreover, depending upon actual instrumentation and/or equipment used for implementing a particular preferred embodiment of the disclosed system and corresponding method, several embodiments of the present invention could be achieved manually or automatically.

### BRIEF DESCRIPTION OF THE DRAWINGS

The present invention is herein described, by way of example only, with reference to the accompanying drawings. With specific reference now to the drawings, it is stressed that the particulars shown are by way of example and for purposes of illustrative discussion of the preferred embodiments of the present invention only, and are presented in order to provide what is believed to be the most useful and readily understood description of the principles and conceptual aspects of the present invention. In this regard, no attempt is made to show structural details of the present invention in more detail than is necessary for a fundamental understanding of the invention, the description taken with the drawings making apparent to those skilled in the art how the several forms of the invention may be embodied in practice. Identical structures, elements or parts which appear in more than one figure are preferably labeled with a same or similar number in all the figures in which they appear. In the drawings:

FIGS. 1A, 1B, are an illustration of a dynamic tray, in accordance with the present invention;

FIG. 2 is an illustration of a conformal tray, in accordance with the present invention;

FIG. 3 is an illustration of a conformal tray with embedded sensors, in accordance with the present invention;

FIG. 4 is an illustration of a conformal tray with an external vibration mechanism, in accordance with the present invention;

FIG. 5 is an illustration of a conformal tray with an embedded vibration mechanism, in accordance with the present invention;

FIG. 6 is an illustration of a conformal tray with an embedded vibration mechanism and embedded sensors, in accordance with the present invention;

FIG. 7 is an illustration of a conformal tray with an embedded vibration mechanism, external vibration mechanism, and embedded sensors, in accordance with the present invention;

FIG. 8 is an illustration of a conformal tray with an embedded inhaling and jetting tubes, external vibration mechanism, and embedded sensors, in accordance with the present invention; and

FIG. 9 is an illustration of a trace collection system with a conveyer system, partially enclosed by a tunnel, for preparation of the article to be inspected in accordance with the present invention;

### DETAILED DESCRIPTION OF THE PREFERRED EMBODIMENTS

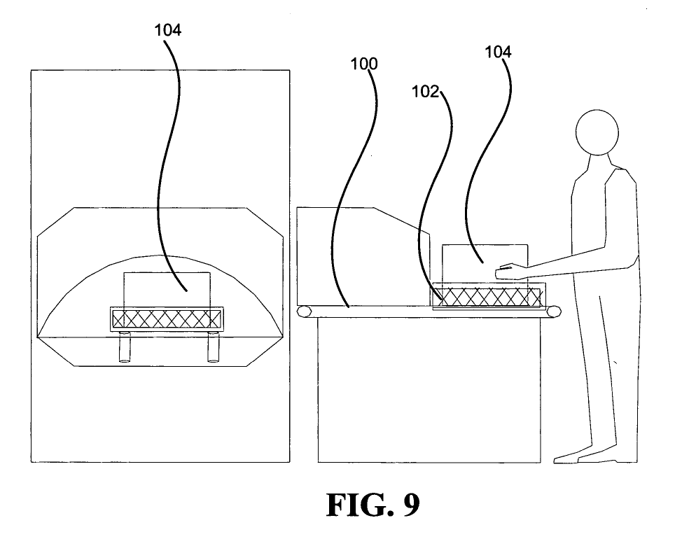

Referring to the figures, FIG. 9 is an illustration of a trace collection system with a conveyer system, partially enclosed by a tunnel, for preparation of the article to be inspected. FIG. 9 features the following elements: (a) conveyor 100, (b) tray 102, and (c) inspected item 104.

The present invention is not limited in its application by the details of the order or sequence of steps of operation or implementation of the method and/or the details of construction, arrangement, and composition of the components of the device set forth in the following description, drawings or examples. While specific steps, configurations and arrangements are discussed, it is to be understood that this is done for illustrative purposes only. A person skilled in the relevant art will recognize that other steps, embodiments, configurations and arrangements can be used without departing from the spirit and scope of the present invention.

The present invention is capable of other embodiments or of being practiced or carried out in various ways. Also, it is to be understood that the phraseology, terminology and notation employed herein are for the purpose of description and should not be regarded as limiting.

In an embodiment option of the present invention, the tray is made of disposable material, meaning that the tray can be safely discarded when necessary. For example, any event that renders the tray contaminated, unsafe or undesirable for reuse. Or, if the inspected items are found to have trace particles that are classified as predefined suspect materials such as, but not limited to, explosives, drugs, toxic materials, hazardous materials, or materials that are otherwise unfit to handle and a possible threat to public safety—while taking into account that trace collection systems may operate in congested areas and/or that the trace collection system must be clean and not contaminated by the predefined suspected materials, if the tray cannot be cleaned or decontaminated, the operator should be able to dispose of the tray in order to ensure public safety and/or prevent possible contamination of the trace collection system.

Specifically, tray disposal is useful for preventing contamination of the inspection equipment and surrounding, including the trace collection system after hazardous materials have been detected, meaning that tray disposal is a standard step in the trace collection system cleaning process after a contamination event. Applying this measure reduces the incidence of false alarms. Optionally, as a preventive measure, a tray can be disposed of after either a single use or after a number of uses, or at the operator's discretion.

In another embodiment option of the present invention, the tray upon which inspected items are placed during the trace collection process is of fixed form. This means that the operator, the inspected items, or any other mechanical element or human interaction with the tray cannot, under reasonable application of force alter, deform or otherwise reshape the tray. It is preferable that the particle collection process not take a possible deformity in the shape of the tray as a parameter. Doing so can complicate, lengthen, and/or otherwise impede the particles collection process. Some of the trace collection process phases are distinguished by vibration, possibly at resonance. The tray should be able to withstand repeated exposure to the forces exerted during the trace collection process, and not alter its makeup in shape, contour, density, number of components, or any other property that can hinder or in any other way influence the trace collection process.

Optionally, the shape of the tray can take many forms. Fixed forms that compartmentalize the tray into more than one section are designed to hold an inspected item, or inspected items, of specific size and weight. This can improve the process by shortening the particles collection time.

In an embodiment option of the present invention, a particles collection cycle is performed on multiple inspected items simultaneously. This embodiment shortens the overall process. The advantage is more evident in cases where setup time is significant, such as when using heating elements.

A fixed tray shape can also prevent inspected items from experiencing dislocation during the trace collection process, due to forces exerted on the inspected items in the chamber during collection movement of inspected items inside the chamber may interfere with the collection process.

In an embodiment option of the present invention, the dynamic tray of the present invention features a rigid and or elastic center area and a rigid outer rim (or part of the outer rim). The inspected items are placed on the center area. While the area is propped up by the conveyor—a horizontal and solid surface. As the dynamic tray enters the trace collection system, it is supported by handles or mechanisms that only grasp the rigid outer rim of the tray. The elastic center then assumes the shape of the inspected items since there is no longer a supporting surface beneath the elastic region. Optionally, the particles collection process is performed on the inspected items in a hanging posture. Alternatively, the collection process is performed on the inspected items in any other posture as required.

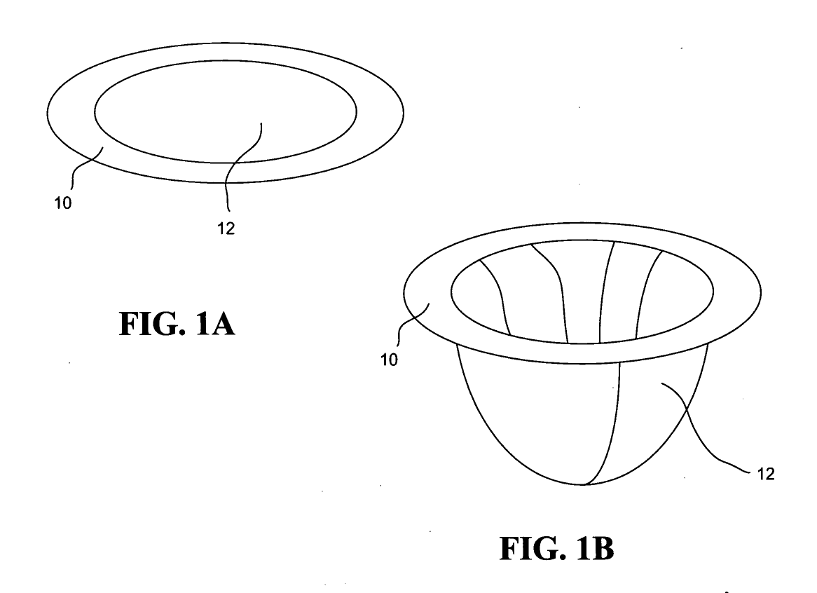

Referring to FIG. 1A and FIG. 1B, in an embodiment option of the present invention, the dynamic tray features the following components: rigid outer rim 10, and rigid or elastic center area 12.

According to another optional embodiment, at least one section of the outer rim is rigid. The at least one rigid section should feature enough length to secure the flexible part as well as to be connected to the particles collection system.

In another embodiment option of the present invention, the tray shape can alter shape. The tray can assume different spatial dimensions according to a predefined set of constraints. A valid predefined set of constraints on the shape of the tray manifests as a shape that assumes different spatial dimension or properties while supporting the inspected items and not compromising the trace collection process.

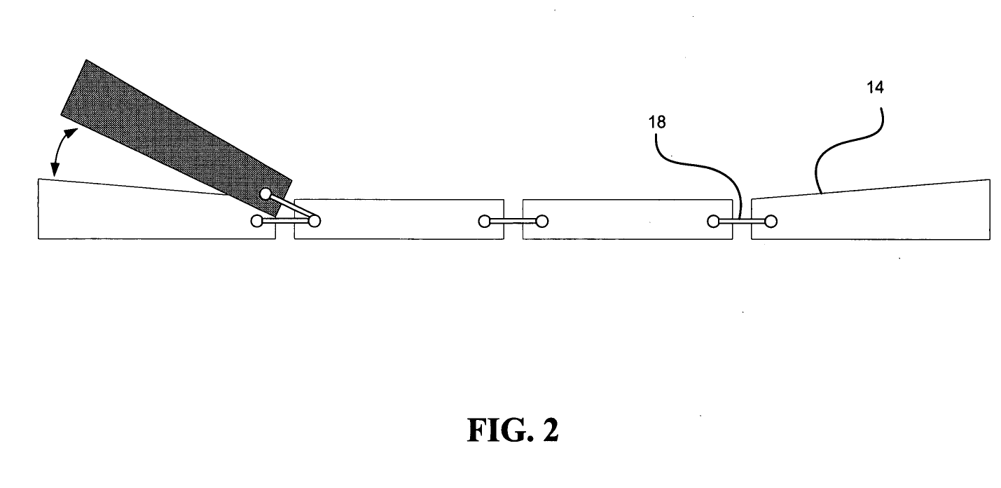

Referring to FIG. 2, in an embodiment option of the present invention, the conformal tray features the following components: a rigid or elastic tray element 14 and a flexible connecting joint 18. In this embodiment of the present invention an optional method for conforming the tray's shape is performed by composing the tray out of numerous rigid and elastic elements, and connecting the rigid and elastic elements using flexible joints. Optionally altering the tray configuration or shape can be achieved by relocating parts of the tray surface in a way that does not dismember the tray into more than one entity. For example, a tray's shape can be altered if an area belonging to it is joined to another by a metallic, plastic, or any other form of mechanical joint. The operator can set the shape of the tray using these joints in such a way that it conforms to the contours of the inspected items. The method of assuming different shapes can also use any mechanism to dynamically change the shape profile of the conjoined areas by any means applicable to modify the shape profile. For example, a tray that has embedded tubes containing air or fluids can change shape upon changing of the pressure inside the tubes, resulting in a controlled shift in the shape of the tray.

Dynamically changing the shape of the tray, according to the size and shape of the inspected items, as well as to the trace collection cycle requirements, is advantageous since the air jets or inlets and exhaust drain components can be positioned relative to the inspected item at different locations as needed during the trace collection cycle. In addition, conforming the shape of the tray to the article reduces the volume of air to be collected.

In an embodiment option of the present invention, a multiple tray device is used. Multiple tray device can hold multiple parallel trays placed one on top of another, side by side trays, and one inside another. Performing a trace collection process on multiple inspected items can shorten the overall process, resulting in increased throughput and lighter wear on device components. It will also reduce resources needed to execute the trace collection process hence reducing overall inspection costs.

In another embodiment option of the present invention, liquid detection sensors are integrated within the tray to in order to cause an alert in case the presence of spillage is detected and to halt the trace collection process. Liquid originating from the inspected items which makes its way to the surface of the tray will come in contact with the liquid detection sensor embedded in the tray. The operator can quickly stop the machine, or the machine controls may stop the machine, mid cycle and disengage the tray, hence, reducing the possibility of liquid causing damage to the trace collection system or its components.

The collection of liquid on the tray may be an indication that one or more of the trace collection machine parameters are out of range or point to some other malfunction in the collection device. For example, a container in the inspected items may have been subjected to excessive vibration, thus causing the walls of the container to crack and release liquid.

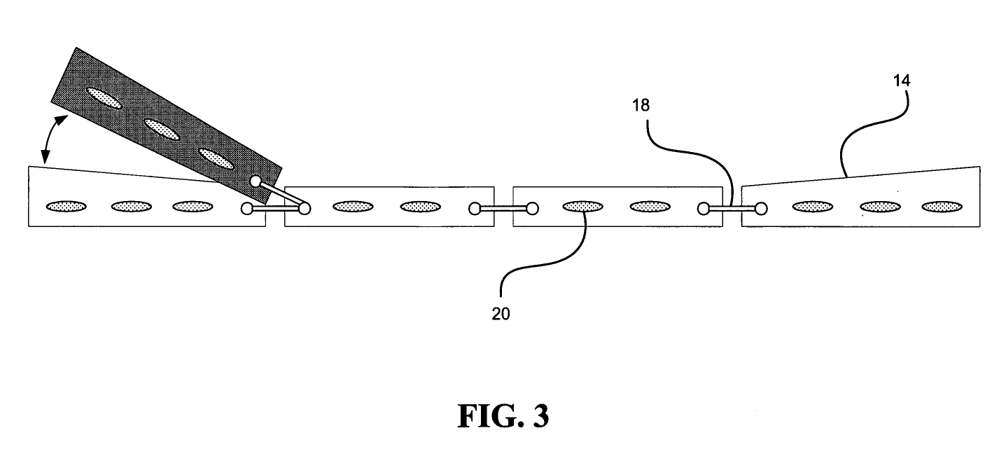

Referring to FIG. 3, in an embodiment option of the present invention, the conformal tray features the following components: a rigid or elastic tray element 14, a flexible connecting joint 18, and an embedded sensor 20 designating an integrated liquid detection sensor.

In another embodiment option of the present invention, sound measurement sensors are integrated within the tray to alert for a problem in the trace collection process. Sound originating from the inspected items during the collection process can indicate a malfunction, or that an inspected item is being deformed or otherwise agitated to excess. If this occurs, the operator, for example, can quickly stop the machine or the machine controls may stop the machine, mid-cycle and disengage the tray, avoiding further damage to the inspected article, its contents as well as to the trace collection system.

In another embodiment option of the present invention, there is vibrating of the inspected items. Vibrating the inspected items increases the probability that traces within the inspected items dislodge and become more susceptible to forces caused by air movement inside the inspected item. Vibrating the inspected items improves the effectiveness of the collection process since it increases the number of particles freed from surfaces and which may then be collected.

In an embodiment option of the present invention, vibration is achieved by an embedded vibration devices within the tray, or by vibration devices external to the tray. In some cases, embedded vibration mechanisms may improve on other vibrating mechanisms that cause movement of the tray and inspected items as a whole. Disadvantages of this approach are potential imperilment of fragile inspected items that may result in damage to the inspected items themselves and possibly to the trace collection system as well, in the event that the vibrations transform the inspected items in a way that renders them obtrusive to the normal operation of the trace collection system.

In this embodiment, the tray is designed to transfer the vibration and cause the particles in the inspected items to dislodge. In case the tray is composed of numerous sections, the rigid sections may be vibrated by mechanical means, while the softer sections may be agitated using embedded pneumatic mechanics or by other mechanical, acoustic, or other method in order to create vibrations in the tray. The timing of the vibrations in each section is set in a way that causes a non random directional wave to propagate across the tray. For example, a wave can be made to originate from the center of the tray and propagate to the outer regions.

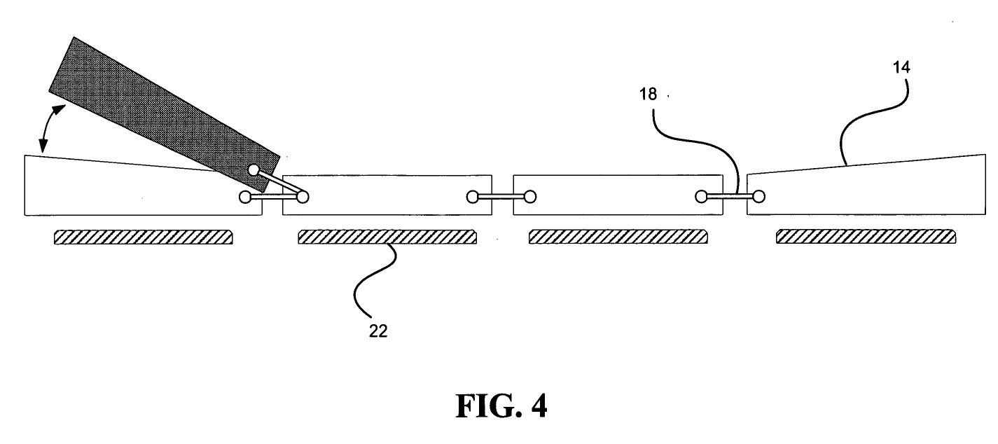

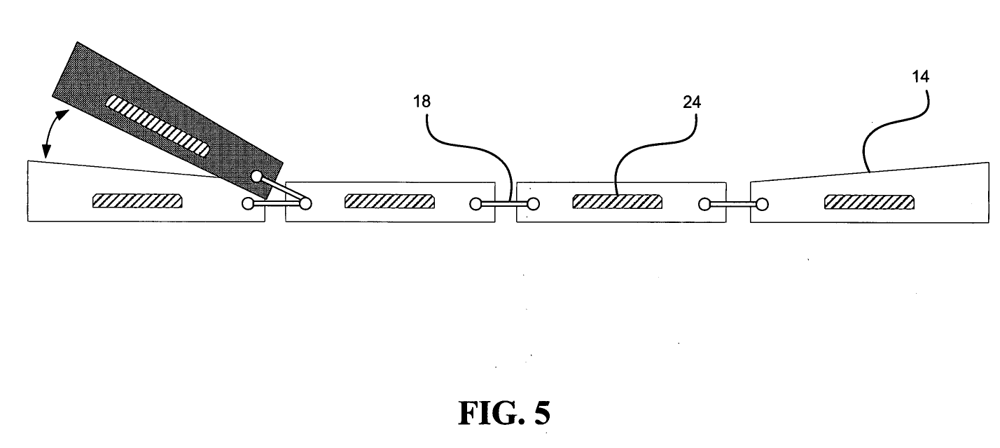

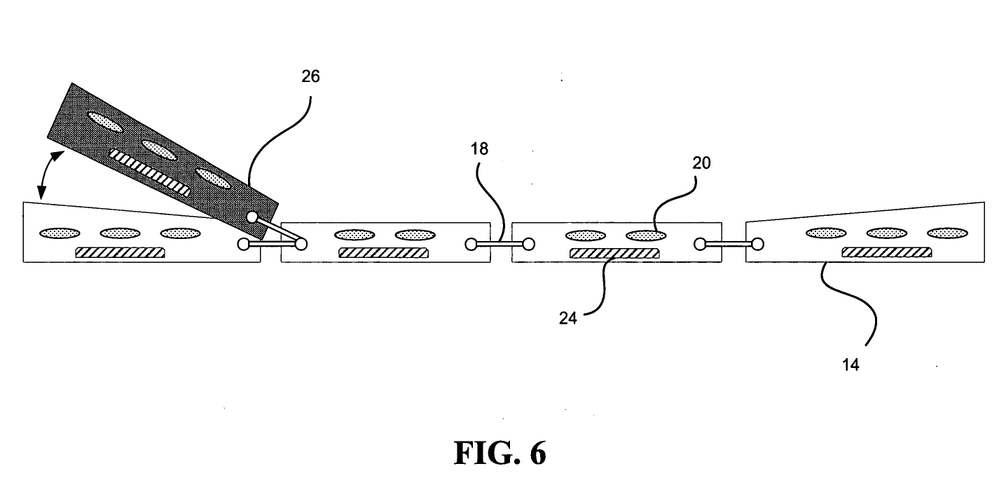

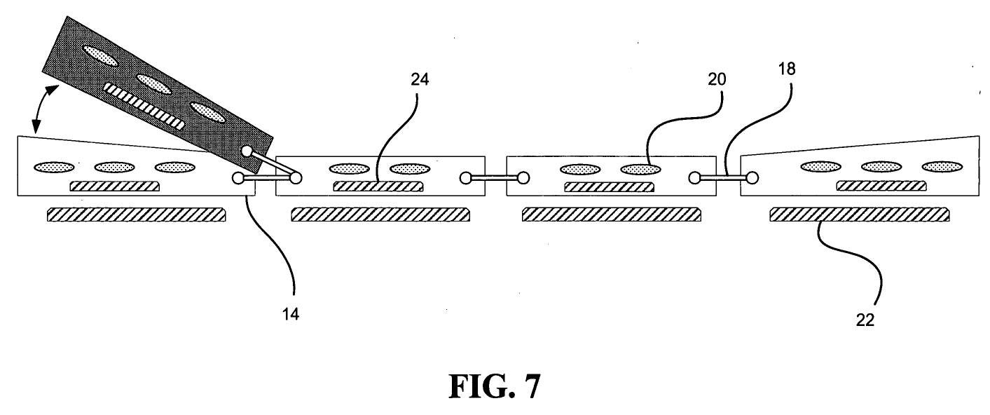

Referring to FIG. 4, in an embodiment option of the present invention, the conformal tray features the following components: a rigid or elastic tray element 14 a flexible connecting joint 18 and an external vibrating mechanism 22. Referring to FIG. 5, in an embodiment option of the present invention, the conformal tray features the following components: a rigid or elastic tray element 14, a flexible connecting joint 18, and an embedded mechanism 24 designating an integrated vibrating mechanism. Referring to FIG. 6, in an embodiment option of the present invention, the conformal tray features the following components: a rigid or elastic tray element 14, a flexible connecting joint 18, and an embedded vibrating mechanism 24, an integrated liquid detection sensor 20, and a rigid or elastic tray element 26 that is dislocated from its initial horizontal position in order to conform with the inspected items (not shown in the figure). Referring to FIG. 7, in an embodiment option of the present invention, the conformal tray features the following components: a rigid or elastic tray element 14, a flexible connecting joint 18, and an embedded vibrating mechanism 24, an integrated liquid detection sensor 20, and an external vibrating mechanism 22.

In another embodiment option of the present invention, sensors are embedded in the tray for measuring the dimensions of the inspected items. Width, height and length estimates can serve as parameters in the optimization of the trace collection process. An estimation of spatial dimensions width, height, and length) can assist when one or more automated process that comprise the trace collection method is set in motion to agitate particles within, on the surface of, and around the inspected items. For example, larger dimensions may possibly denote heavier inspected items that require more rigorous agitation such as more forceful vibration or a longer heating period.

In another embodiment option of the present invention, weight measurement sensors are embedded in the tray for gauging the weight of the inspected items. Weight estimations may serve as parameters in the particles collection process, in cases where one or more discrete phases of the particles collection process can benefit from the input of the inspected items' weight. knowledge of the weight can assist when one or more automated process that comprise the particles collection method is set in motion to agitate particles within, on the surface of, and around the inspected items. For example, heavier inspected items may need more rigorous agitation such as more forceful vibration or a longer heating period.

In another embodiment option of the present invention, data from integrated dimension and weight measurement sensors is used to compute a gross density of the inspected items. The gross density may be related to the level of effort that is required to extract particles from the inside of the inspected items and can thus be used to control the type of process applied to the inspected article.

In another embodiment option of the present invention, the particle collection process is tailored in accordance with the physical dimension of the tray. A circular tray can prove beneficial with regard to particle collection efficiency, and the overall physical footprint of the particle collection system. The method of scanning the inspected items when using a revolving circular tray is similar to the regular process described above, but otherwise distinct because the same process is performed anew every predefined degrees of revolution.

The physical makeup of the trace collection system is modified according to the revolving element. Jetting and inhaling components need to be concentrated in one area instead of being spread out in a formation that provides complete coverage of the inspected items. The same jetting and inhaling elements will be used repetitively on different parts of the inspected items, with every predefined degrees of revolution of the circular tray. Moreover, the physical makeup of the trace collection system is further modified since less tubing is required due to the reduced number of jetting and inhaling components. This decreases Bill of Materials (BOM) since the trace collection system requires fewer components, while there is a negligible element of cost involved in altering the tray mechanism to support circular movement.

The physical makeup of the trace collection system is further modified since fewer inhaling and jetting components are required. This decreases BOM since the trace collection system requires fewer components, while there is a negligible element of cost involved in altering the tray mechanism to support circular movement.

In addition, the decreased need for inhaling and jetting components and respective tubing reduces the risk of contamination that is in proportion to the distance the particles must traverse from the inspected items to the analyzer.

In another embodiment option of the present invention, input from weight and dimension measurement sensors is used to provide input to the control parameters of the trace collection system which have dependence on these inputs. Trace collection parameters can thus be optimized according to the inspected items' estimated shape and weight. The resulting vibration profile can include a series of vibrations, varying in duration and intensity, perhaps including estimates of natural frequencies of the inspected items. The vibration series can include then a series of vibration frequencies at or near these natural frequencies to maximize particle movement and increase the probability of particle trapping based on the inspected items' weight and dimensions. Moreover, active measurement of the acceleration of the inspected items will reveal the actual resonant frequencies and the vibration frequency can be adjusted accordingly to maximize energy input to the particles.

In another embodiment option of the present invention, the vibration frequency is far from the possible natural resonance frequency of the contents of the inspected article so as not to creat damage to sensitive items.

In another embodiment option of the present invention, at least one heating device is embedded in the tray of the present invention. Heating the inspected items increases the probability that particles within the inspected items dislodge and thus be more available to entrainment by air movement inside the inspected items and/or inside the testing chamber. This improves the effectiveness of the particles collection since this increases the number of particles available for capture. Moreover, in some cases it is necessary to heat the inspected items before the particles collection process starts.

In another embodiment option of the present invention, temperature measurement sensors are embedded in the tray. The embedded temperature measurement sensors are measuring the average temperature of the inspected items. Temperature readings can serve as parameters to the trace collection process, in cases where one or more discrete phases of the collection process can benefit from the temperature of the inspected items.

The embedded temperature measurement sensor provides a safety mechanism since it can trigger a fire extinguishing mechanism in the event that the temperature read rises above a pre-determined degree indicating a fire is present. The fire extinguishing method relies on the integration of the embedded temperature measurement sensor and embedded inhaling components. In the event the embedded temperature measurement sensors read a temperature that is higher than a predetermined degree, suggesting a fire, the inhaling component is activated. Air is pumped out of the conforming mechanism at a rapid pace, in an attempt to suffocate the detected combustion.

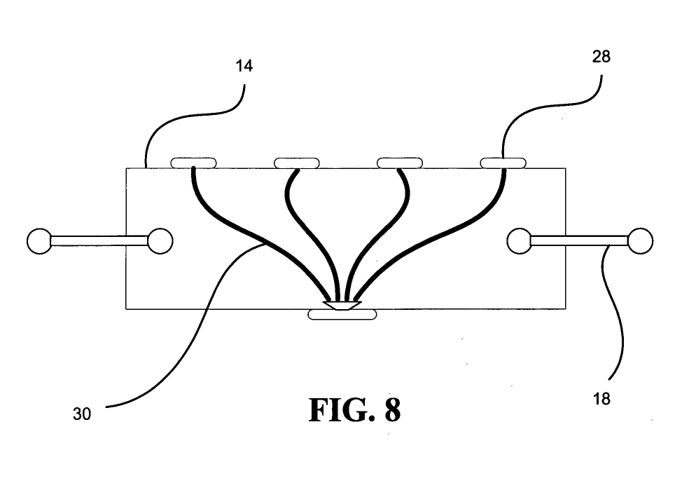

In another embodiment option of the present invention, the tray contains integrated inhaling components. The terminal of the inhaling component on the surface of the tray is surrounded by an enclosing raised surface. For example, if the terminal inhaling component is of circular shape, it will be surrounded by an enclosing ring with a top surface that is elevated from the tray's surface. Referring to FIG. 8, in an embodiment option of the present invention, the conformal tray features the following components: a rigid or elastic tray element 14, a flexible connecting joint 18, tubes illustrating integrated inhaling components 30, and a terminal illustrating the terminal of the inhaling component on the surface of the tray 28.

In another embodiment option of the present invention, the tray contains integrated jetting components. The terminal of the jetting component on the surface of the tray is surrounded by an enclosing raised surface. For example, if the terminal jetting component is of circular shape, it will be surrounded by an enclosing ring with a top surface that is elevated from the tray's surface.

This is advantageous for the jetting process. The resulting area between the jetting terminal and the inspected items facilitates the jetting process and ensures that there is a sufficient amount of initial volume to be pumped, in order to ensure a potentially uniform dispersal of air in close proximity of the jetting terminal. Moreover, jets in the tray have the benefit that they are very close to the inspected items and therefore more effective than any jets which are not as close.

In another embodiment option of the present invention, integrated weight measurement sensors serve as binary indicators for the inhaling and jetting components embedded in the tray. The binary indicator readings serve as input to the inhaling and jetting component controller, and can be used for selective activation. This results in a subset of inhaling and jetting components being activated according to the dimensions of the inspected items.

In another embodiment option of the present invention, the tray, whether of fixed or dynamic shape, has a cover that prevents loose inspected items from becoming displaced during the particle collection process.

The tray cover may be composed of at least one single element, flat or curved, or may be similar to the tray—i.e. composed of multiple elements that may be rigid and/or non-rigid, including the disclosed sensors and actuation devices and methods.

The operator is responsible for maintaining the cleanliness of the tray, as part of the standard operation of the trace collection system. Cleaning, and the removal of particles from the tray that do not take part in forming its initial composition, is achieved by gas flow, vapor submersion, wet cleaning, dry cleaning, or agitation. The tray can be used in multiple particle collection sessions, and be cleaned at the operator's discretion, across sessions.

In another embodiment option of the present invention, the trays are automatically circulated from the out-port side of the trace collection system to the in-port side. The recirculation process can be done while the trays are horizontal in relation to the trace collection system (large area facing top or down or vertical in relation to the trace collection system (large area facing side ways). Tray circulation can be performed either around the machine, or from above or below it, in an escalator method. Cleaning the trays can be done automatically, during the tray circulation process.

In an embodiment option of the present invention, the trace collection system has a modular conveyor appended to the entrance of the device. The conveyor is protected by a hood, and/or enclosed in a tunnel, so as not to allow people standing by to see the inspected items entering the trace collection system, and for safety reasons, such as to prevent people from inserting inspected items into the trace collection system. The conveyor can perform preliminary checks on the inspected items, and gather information such as weight, dimension, and temperature, that can serve as parameters to the subsequent trace collection process. Stacking functionality on the conveyor allows a streamlined design of the particles collection device.

It is to be understood that the term “conveyor” as used herein is not intended to limit the scope of the present invention and is not limited to a device for moving objects automatically. The term “conveyor” may refer to any preparation stage, or preparation means, or article preparation for a trace collection system, or an advanced tray.

In another embodiment option of the present invention, the conveyor includes a heating element that raises the temperature of the inspected items prior to them entering the particle collection device. Heating the inspected items increases the probability that particles within the inspected items dislodge and subsequently become more susceptible to motion caused by air movement inside the inspected item and the trace collection system. This improves the effectiveness of the collection since the particle sample will be denser with heating. Moreover, in some cases it is necessary to heat the inspected items before the trace collection process starts.

In another embodiment option of the present invention, liquid detection sensors are integrated within the conveyor can serve as either an automated or manual warning sign, to halt the process. Liquid originating from the inspected items that makes its way to the surface of the conveyor will come in contact with the liquid detection sensor embedded in the conveyor. The operator can quickly stop the machine mid-cycle, hence, reducing the possibility of liquid causing damage to the conveyor, trace collection system or its components.

The collection of liquid on the conveyor is an indication that one or more of the trace collection parameters are out of operating range or point to some other malfunction in the collection device. For example, a container in the inspected items may have been subjected to excessive vibration causing the walls of the container to crack and release liquid.

In another embodiment option of the present invention, sensors embedded in the conveyor are measuring the weight of the inspected items. Weight estimations can serve as parameters to the trace collection process, in cases where one or more discrete phases of the trace collection process can benefit from knowledge of the weight of the inspected item. Knowledge of weight can assist when one or more automated processes that comprise the trace collection method are set in motion to agitate particles within, on the surface of, and around the inspected items. For example, heavier inspected items may need more rigorous agitation such as more forceful vibration or a longer heating period.

In another embodiment option of the present invention, sensors embedded in the conveyor, or in its vicinity, such as with imaging sensors, measure the dimensions of the inspected items. Knowledge of these dimensions can serve as parameters to the trace collection process, in cases where one or more discrete phases of the trace collection process can benefit from the spatial dimensions of the inspected items. Knowledge of spatial dimensions (width, height, and length) can assist when one or more automated processes that comprise the trace collection method are set in motion to agitate particles within, on the surface of, and around the inspected items. For example, larger dimensions may possibly denote heavier inspected items that require more rigorous agitation such as more forceful vibration or a longer heating period.

In another embodiment option of the present invention, temperature measurement sensors embedded in the conveyor or in its vicinity, such as with IR imaging sensors measure the average temperature of the inspected items. Temperature readings can serve as parameters to the trace collection process, in cases where one or more discrete phases of the trace collection process can benefit from the input of the inspected items' temperature. An estimation of temperature can assist when one or more automated processes that comprise the collection method are set in motion to agitate particles within, on the surface of, and around the inspected items.

In another embodiment option of the present invention, the conveyor features a vibration mechanism. Vibrating the inspected items increases the probability that particles within the inspected items dislodge and subsequently be more susceptible to motion caused by air movement inside the chamber. This improves the reliability of the trace collection process since the particles are more uniformly distributed across the body of inspected items.

Optionally, the vibration is achieved by embedded vibration devices within the conveyor, or by vibration devices external to the conveyor. Embedded vibration mechanisms improve on other vibrating mechanisms that instigate the movement of the tray and inspected items as a whole. The conveyor is designed to transfer the vibration and cause the particles in the inspected items to dislodge. The timing of the vibrations can be set in a way that causes a non random directional wave to propagate across the conveyor. For example, a wave can propagate from the center of the conveyor to the outer regions, or form one side to the other. Timing of the vibrations is also calculated to create a non random directional wave taking in account the conveyor's velocity while the in motion.

It is appreciated that certain features of the invention, which are, for clarity, described in the context of separate embodiments, may also be provided in various combinations in a single embodiment. Conversely, various features of the invention, which are, for brevity, described in the context of a single embodiment, may also be provided separately or in any suitable sub-combination.

All publications, patents and patent applications mentioned in this specification are herein incorporated in their entirety by reference to the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described in conjunction with specific embodiments and examples thereof, it is to be understood that they have been presented by way of example, and not limitation. Moreover, it is evident that many alternatives, modifications and variations will be apparent to those skilled in the art. Accordingly, it is intended to embrace all such alternatives, modifications and variations that fall within the spirit and broad scope of the appended claims and their equivalents.

What is claimed is:

1. A trace collection system comprising:
(a) at least one preparation stage for at least one inspected item, whereby said inspected item is enclosed in a tunnel, and
(b) a particle collection system,
whereby said particle collection system collects a portion of the released particles and said portion of the released particles is analyzed for traces of at least one predefined chemical.

2. The system of claim 1 further comprising at least one encapsulating device having volume determined according to said inspected item.

3. The system of claim 1 further comprising a particle release mechanism applied on said inspected item.

4. The system of claim 1 wherein said preparation stage is a conveyor.

5. The system of claim 4 wherein said conveyor further comprises at least one liquid detection sensor.

6. The system of claim 4 wherein said conveyor further comprises at least one sound measurement sensor.

7. The system of claim 4 wherein said conveyor further comprises at least one vibrating mechanism.

8. The system of claim 4 wherein said conveyor further comprises at least one dimension measurement sensor.

9. The system of claim 4 wherein said conveyor further comprises at least one weight measurement sensor.

10. The system of claim 4 wherein said conveyor further comprises at least one heating device.

11. The system of claim 4 wherein said conveyor further comprises at least one temperature measurement sensor.

12. A method for forming a chamber around at least one inspected item, applying at least one particle release measure on said inspected item, and collecting released particles, comprising the step of preparing said inspected item before said inspected item is encapsulated.

13. The method of claim 12 wherein said preparing further comprises the step of detecting the presence of a possible spillage.

14. The method of claim 12 wherein said preparing further comprises the step of vibrating said inspected item.

15. The method of claim 12 wherein said preparing further comprises the step of measuring the dimensions of said inspected item, whereby the measurements serve as parameters in an optimization of the particle collection process.

16. The method of claim 12 wherein said preparing further comprises the step of measuring the weight of said inspected item, whereby the weight measurements serve as parameters in an optimization of the particle collection process.

17. The method of claim 12 wherein said preparing further comprises the step of measuring the weight and dimensions of said inspected item, whereby the weight and dimensions measurements are used to compute a gross density of said inspected item.

18. The method of claim 12 wherein said preparing further comprises the step of heating said inspected item.
